(19) United States
(12) Patent Application Publication
(10) Pub. No.: US 2025/0005405 A1
(43) Pub. Date: Jan. 2, 2025

(54) REGRESSION ESTIMATION DEVICE, REGRESSION ESTIMATION METHOD, PROGRAM, AND METHOD FOR GENERATING TRAINED MODEL

(71) Applicant: FUJIFILM Corporation, Tokyo (JP)

(72) Inventor: Keita OTANI, Tokyo (JP)

(73) Assignee: FUJIFILM Corporation, Tokyo (JP)

(21) Appl. No.: 18/587,965

(22) Filed: Feb. 27, 2024

Related U.S. Application Data
(63) Continuation of application No. PCT/JP22/25288, filed on Jun. 24, 2022.

(30) Foreign Application Priority Data
Aug. 31, 2021 (JP) 2021-141458

(51) Int. Cl. G06N 7/01; G06T 7/00

(52) U.S. Cl. CPC G06N 7/01; G06T 7/0012

(57) ABSTRACT

Provided is a regression estimation device that can improve accuracy of estimation in a case where estimation results obtained by performing a plurality of inputs are integrated to derive one estimated value. A regression estimation device includes one or more processors and one or more storage devices that store a program to be executed by the one or more processors. The one or more processors execute commands of the program to receive an input of a plurality of data items, to input the plurality of data items to a single regression model to estimate a plurality of sets of estimated values and certainties of the estimated values from the plurality of data items, and to integrate estimation results of the plurality of sets on the basis of the plurality of sets of the estimated values and the certainties of the estimated values estimated by the regression model.

### CROSS-REFERENCE TO RELATED APPLICATIONS

The present application is a Continuation of PCT International Application No. PCT/JP2022/025288 filed on Jun. 24, 2022 claiming priority under 35 U.S.C § 119(a) to Japanese Patent Application No. 2021-141458 filed on Aug. 31, 2021. Each of the above applications is hereby expressly incorporated by reference, in its entirety, into the present application.

### BACKGROUND OF THE INVENTION

### 1. Field of the Invention

The present disclosure relates to a regression estimation device, a regression estimation method, a program, and a method for generating a trained model, and more particularly, to an information processing technique that performs regression estimation of estimating a numerical value of an objective variable on the basis of input data.

### 2. Description of the Related Art

A technique is known which performs a regression estimation process using a machine learning algorithm such as a deep learning algorithm. In the field of machine learning, there is known a method called an ensemble that integrates estimation results for one input by a plurality of learning models to improve estimation performance in order to improve the estimation accuracy of a process of performing estimation corresponding to an input. “Averaging” is widely used to integrate the estimation results. It is known that performance is improved in a case where weighting and averaging are performed according to the performance of a learning model.

Meanwhile, there is also a method that dynamically changes a weight according to the input, instead of fixing the average weight. Daniel Jimenez, “Dynamically Weighted Ensemble Neural Networks for Classification”, 1998 IEEE international joint conference on neural networks proceedings: IEEE world congress on computational intelligence (Cat. No. 98CH36227) (1998) discloses a configuration in which a weight for an inference result in which a certainty factor is near a boundary value (0.5) is reduced in a case where a plurality of inference results for a classification problem are integrated.

In addition, there is a method that uses a weighted median instead of the weighted average in a case where estimation results are integrated. Jose L. Paredes, and Gonzalo R. Arce, “Compressive Sensing Signal Reconstruction by Weighted Median Regression Estimates” IEEE TRANSACTIONS ON SIGNAL PROCESSING, VOL. 59, NO. 6, JUNE 2011 discloses a configuration in which inference results obtained from a plurality of linear regression models are integrated with a weighted median for each model. JP6622329B discloses a method that estimates valence (induced) values and arousal values as music impression values from music acoustic signals using a plurality of regression models and integrates a plurality of estimation results obtained by the plurality of regression models.

Further, as another method, a method is known in which a plurality of different inputs are performed on one learning model and a plurality of estimation results obtained from the plurality of inputs are integrated to improve estimation performance. In Guotai Wang, Wenqi Li, Michael Aertsen, Jan Deprest, Sebastien Ourselin, Tom Vercauteren, “Aleatoric uncertainty estimation with test-time augmentation for medical image segmentation with convolutional neural networks” Neurocomputing 338 (2019) 34-45, in a case where a regression problem is solved, a plurality of images are created by, for example, rotating or inverting one image and then estimated values corresponding to the number of inputs, which have been obtained by inputting the plurality of images to a learning model, are averaged to obtain a final result.

A normal deep regression model does not output a certainty factor for an estimated value. However, in Alex Kendall, Yarin Gal, “What Uncertainties Do We Need in Bayesian Deep Learning for Computer Vision?” 31st Conference on Neural Information Processing Systems (NIPS 2017), Long Beach, CA, USA., a deep learning machine outputs the average and standard deviation of a normal distribution to obtain the certainty factor of regression.

### SUMMARY OF THE INVENTION

In a case where a plurality of estimation results obtained by a plurality of inputs are integrated, the method using the average has the disadvantage that, in a case where the plurality of estimation results include a value that deviates significantly, the error of the estimated value (final result) after the integration is large. In this regard, the weighted median is used in Jose L. Paredes, and Gonzalo R. Arce, “Compressive Sensing Signal Reconstruction by Weighted Median Regression Estimates” IEEE TRANSACTIONS ON SIGNAL PROCESSING, VOL. 59, NO. 6, JUNE 2011. However, this method is targeted for linear regression and the weight is not dynamically changed depending on the input.

In the method disclosed in Guotai Wang, Wenqi Li, Michael Aertsen, Jan Deprest, Sebastien Ourselin, Tom Vercauteren, “Aleatoric uncertainty estimation with test-time augmentation for medical image segmentation with convolutional neural networks” Neurocomputing 338 (2019) 34-45, the final result is obtained by simply averaging a plurality of estimated values obtained from the learning model. Therefore, it is not possible to reduce the influence of the input that is not suitable for estimation with weighting. The method disclosed in Alex Kendall, Yarin Gal, “What Uncertainties Do We Need in Bayesian Deep Learning for Computer Vision?” 31st Conference on Neural Information Processing Systems (NIPS 2017), Long Beach, CA, USA. only calculates the certainty factor of regression and is not a mechanism for integrating the estimation results.

The present disclosure has been made in view of these circumstances, and an object of the present disclosure is to provide a regression estimation device, a regression estimation method, a program, and a method for generating a trained model that can improve the accuracy of estimation in a case where estimation results obtained by performing a plurality of different inputs to one (single) regression model are integrated to derive one estimated value.

According to an aspect of the present disclosure, there is provided a regression estimation device comprising: one or more processors; and one or more storage devices that store a program to be executed by the one or more processors. The one or more processors execute commands of the program to receive an input of a plurality of data items, to input the plurality of data items to a single regression model to estimate a plurality of sets of estimated values and certainties of the estimated values from the plurality of data items, and to integrate estimation results of the plurality of sets on the basis of the plurality of sets of the estimated values and the certainties of the estimated values estimated by the regression model.

According to the regression estimation device of this aspect, the plurality of data items are input to the single regression model, the plurality of sets of the estimated values and the certainties of the estimated values corresponding to the input are obtained, and the estimation results are integrated on the basis of the plurality of sets of the estimated values and the certainties of the estimated values to obtain an estimated value as an integration result. During the integration, the certainty of each estimated value is considered. Therefore, the estimated value (final estimated value) as the integration result derived by this aspect can be an estimated value with high accuracy.

The “single regression model” means one type of regression model and may comprise a plurality of processing modules that operate as the same regression model. The term “estimation” includes a concept of inference and prediction. The term “certainty” includes a concept of a certainty and a certainty factor.

According to another aspect of the present disclosure, in the regression estimation device, the one or more processors may estimate a probability distribution having the estimated value as a random variable on the basis of the estimated value and the certainty of the estimated value, integrate the probability distributions of the plurality of sets to generate an integrated distribution, and specify a final estimated value on the basis of the integrated distribution.

According to still another aspect of the present disclosure, in the regression estimation device, the one or more processors may estimate a probability distribution having the estimated value as a random variable on the basis of the estimated value and the certainty of the estimated value and specify a value at which a product of probabilities at the same random variable is maximized on the basis of the probability distribution of each of the plurality of sets.

A value at which a simultaneous probability is maximized can be calculated on the basis of a plurality of probability distributions estimated from the input of the plurality of data items to derive an estimated value with high accuracy in consideration of the certainty estimated according to the input.

According to yet another aspect of the present disclosure, in the regression estimation device, the one or more processors may perform variable conversion to convert the estimated value output from the regression model into a first parameter of a probability distribution model and perform variable conversion to convert a value indicating the certainty output from the regression model into a second parameter of the probability distribution model.

According to still yet another aspect of the present disclosure, in the regression estimation device, the probability distribution model may be a Laplace distribution.

According to yet still another aspect of the present disclosure, in the regression estimation device, the probability distribution model may be a Gaussian distribution.

According to still yet another aspect of the present disclosure, in the regression estimation device, the one or more processors may perform logarithmic conversion to take a logarithm of the probability distribution, calculate a sum of logarithmic probability densities corresponding to the probability distributions of the plurality of sets during the integration, and calculate a value at which a simultaneous logarithmic probability density is maximized.

According to yet still another aspect of the present disclosure, in the regression estimation device, the regression model may include a trained model generated by performing machine learning using training data in which data for input and a teaching signal are associated with each other.

According to still yet another aspect of the present disclosure, in the regression estimation device, the regression model may be configured using a convolutional neural network.

According to yet still another aspect of the present disclosure, in the regression estimation device, the plurality of data items may be medical images.

According to still yet another aspect of the present disclosure, in the regression estimation device, the plurality of data items may be slice images in the same series.

According to yet still another aspect of the present disclosure, in the regression estimation device, the plurality of data items may include different partial images included in a three-dimensional image.

According to still yet another aspect of the present disclosure, in the regression estimation device, the plurality of data items may include generated images that are generated on the basis of different partial images included in a three-dimensional image.

According to yet still another aspect of the present disclosure, in the regression estimation device, the plurality of data items may include different partial images included in a time-series image.

Since the partial images included in the three-dimensional image or the time-series image or the generated images generated from the partial images are used as the input, it is possible to speed up the process while suppressing the deterioration of accuracy.

According to still yet another aspect of the present disclosure, in the regression estimation device, the plurality of data items may include images having different resolutions.

According to yet still another aspect of the present disclosure, in the regression estimation device, the estimated value may be an elapsed time from injection of a contrast agent.

According to still yet another aspect of the present disclosure, in the regression estimation device, the estimated value may be a value indicating a position of a specific object.

According to yet still another aspect of the present disclosure, in the regression estimation device, the estimated value may be a value that indicates a position of the partial image in the three-dimensional image.

According to still yet another aspect of the present disclosure, in the regression estimation device, the estimated value may be an age of a person included in an image which is the input data.

According to yet still another aspect of the present disclosure, there is provided a regression estimation method executed by a processor. The regression estimation method comprises: receiving an input of a plurality of data items; inputting the plurality of data items to a single regression model to estimate a plurality of sets of estimated values and certainties of the estimated values from the plurality of data items; and integrating estimation results of the plurality of sets on the basis of the plurality of sets of the estimated values and the certainties of the estimated values estimated by the regression model.

According to still yet another aspect of the present disclosure, there is provided a program causing a computer to implement: a function of receiving an input of a plurality of data items; a function of inputting the plurality of data items to a single regression model to estimate a plurality of sets of estimated values and certainties of the estimated values from the plurality of data items; and a function of integrating estimation results of the plurality of sets on the basis of the plurality of sets of the estimated values and the certainties of the estimated values estimated by the regression model.

According to yet still another aspect of the present disclosure, there is provided a method for generating a trained model used as a regression model that receives an input of data and outputs an estimated value and a certainty of the estimated value from the data. The method comprises: using training data in which data for input and a teaching signal are associated with each other, inputting the data for input to a learning model, and obtaining an output of the estimated value and a value indicating the certainty of the estimated value from the learning model; performing variable conversion to convert the estimated value output from the learning model into a first parameter of a probability distribution model; performing variable conversion to convert the value indicating the certainty output from the learning model into a second parameter of the probability distribution model; calculating a loss function using the first parameter, the second parameter, and the teaching signal; and updating parameters of the learning model on the basis of a calculation result of the loss function.

The method for generating a trained model is understood as an invention of a method for manufacturing (producing) a trained model.

According to still yet another aspect of the present disclosure, in the method for generating a trained model, the probability distribution model may be a Laplace distribution. In a case where the first parameter is μ, the second parameter is b, and the teaching signal is t, the following expression may be used as the loss function:

$$log b + \vert t - μ \vert / b .$$

According to yet still another aspect of the present disclosure, in the method for generating a trained model, the probability distribution model may be a Gaussian distribution. In a case where the first parameter is μ, the second parameter is σ², and the teaching signal is t, the following expression may be used as the loss function:

$$log {σ}^{2} + {( t - μ )}^{2} / 2 {σ}^{2} .$$

According to the present disclosure, it is possible to derive an estimated value with high accuracy from the input of a plurality of data items to a single regression model.

### BRIEF DESCRIPTION OF THE DRAWINGS

FIG. 1 is a conceptual diagram illustrating an outline of a process by a regression estimation device according to a first embodiment.

FIG. 2 is a diagram illustrating Example 1 of a process of a number-of-seconds distribution estimation unit.

FIG. 3 is a graph of a function y=1/log(1+exp(−x)) used for variable conversion.

FIG. 4 illustrates an example of a graph of a number-of-seconds distribution (Laplace distribution) that is estimated on the basis of parameters and b estimated by the number-of-seconds distribution estimation unit.

FIG. 5 is a diagram illustrating an example of processes of an integration unit and a maximum point specification unit.

FIG. 6 is a diagram schematically illustrating an example of a machine learning method for generating a regression model applied to the number-of-seconds distribution estimation unit.

FIG. 7 is a diagram illustrating a loss function used during training.

FIG. 8 is a block diagram schematically illustrating an example of a hardware configuration of the regression estimation device according to the first embodiment.

FIG. 9 is a functional block diagram illustrating an outline of processing functions of the regression estimation device according to the first embodiment.

FIG. 10 is a diagram illustrating Example 2 of a process of a number-of-seconds distribution estimation unit of a regression estimation device according to a second embodiment.

FIG. 11 illustrates an example of a graph of a number-of-seconds distribution (Gaussian distribution) that is estimated on the basis of parameters μ and σ² estimated by the number-of-seconds distribution estimation unit.

FIG. 12 is a diagram illustrating an example of processes of an integration unit and a maximum point specification unit of the regression estimation device according to the second embodiment.

FIG. 13 is a diagram schematically illustrating an example of a machine learning method for generating a regression model applied to the number-of-seconds distribution estimation unit according to the second embodiment.

FIG. 14 is a diagram illustrating Modification Example 1 of data used for input to the regression estimation device.

FIG. 15 is a diagram illustrating Modification Example 2 of the data used for input to the regression estimation device.

FIG. 16 is a block diagram illustrating an example of a configuration of a medical information system to which the regression estimation device is applied.

### DESCRIPTION OF THE PREFERRED EMBODIMENTS

Hereinafter, preferred embodiments of the present invention will be described with reference to the accompanying drawings.

### Outline of Regression Estimation Device 10 According to First Embodiment

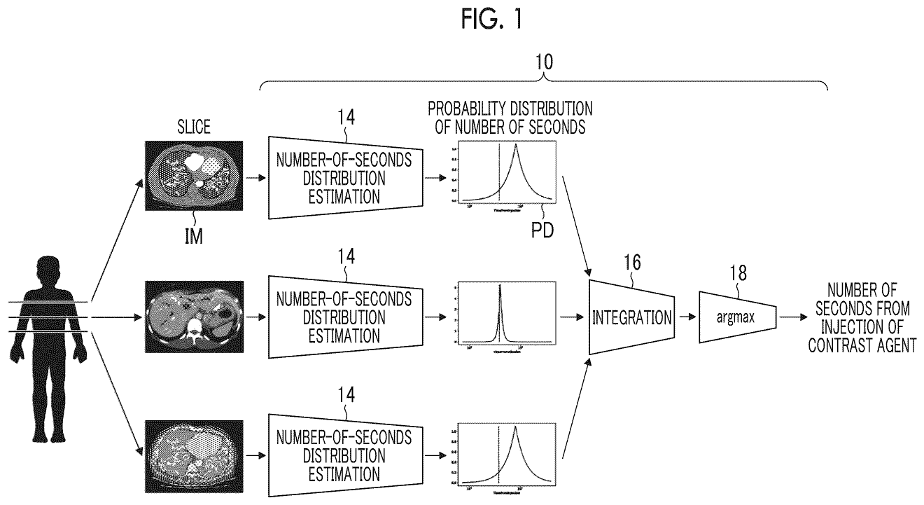

FIG. 1 is a conceptual diagram illustrating an outline of a process by a regression estimation device 10 according to a first embodiment. Here, an example of the regression estimation device 10 that uses, as an input, a plurality of slice images sampled at equal intervals from three-dimensional CT data of a patient captured by a computed tomography (CT) apparatus and estimates the number of seconds from injection of a contrast agent on the basis of the plurality of input slice images will be described. Hereinafter, in the specification, unless otherwise specified, “the number of seconds” includes the meaning of the number of seconds indicating the elapsed time from the injection of the contrast agent. In addition, the slice image may be paraphrased as a tomographic image. The slice image may be substantially understood as a two-dimensional image (cross-sectional image).

The regression estimation device 10 can be implemented using hardware and software of a computer. The regression estimation device 10 includes a number-of-seconds distribution estimation unit 14 that receives the input of images IM and estimates a probability distribution of the number of seconds (hereinafter, referred to as a “number-of-seconds distribution”), an integration unit 16 that integrates a plurality of number-of-seconds distributions PD estimated from a plurality of inputs, and a maximum point specification unit 18 that specifies the number of seconds at which the probability is maximized from a new distribution (hereinafter referred to as an “integrated distribution”) obtained by the integration process. The number of seconds (the number of seconds at which the probability is maximized) specified by the maximum point specification unit 18 is output as a final result.

Further, three number-of-seconds distribution estimation units 14 are illustrated in FIG. 1 in order to illustrate a flow of a process in a case where three different images IM are input. However, the number-of-seconds distribution estimation units 14 to which each image IM is input are the same (single) processing unit.

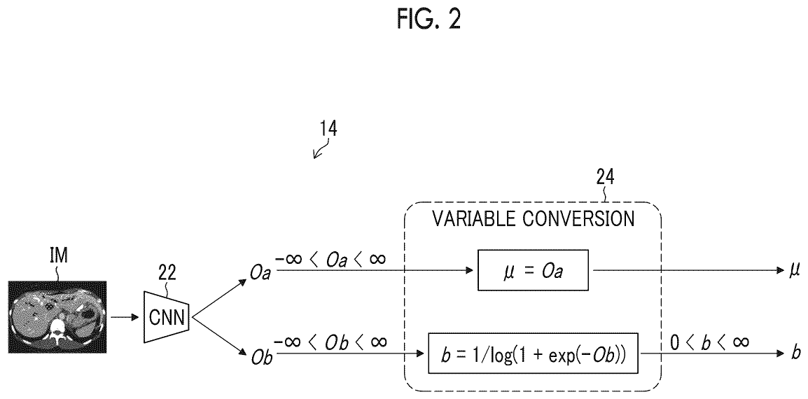

FIG. 2 is a diagram illustrating Example 1 of a process of the number-of-seconds distribution estimation unit 14. The number-of-seconds distribution estimation unit 14 includes a regression estimation unit 22 and a variable conversion unit 24. The regression estimation unit 22 includes a trained model that has been trained by machine learning such that the trained model receives the input of the images IM and outputs an estimated value Oa of the number of seconds and a score value Ob indicating the certainty (certainty factor) of the estimated value Oa. The trained model as a regression model applied to the regression estimation unit 22 is configured using, for example, a convolutional neural network (CNN). The numerical range of the estimated value Oa of the number of seconds output from the regression estimation unit 22 may be “−∞<Oa<∞”, and the numerical range of the score value Ob of the certainty may be “−∞<Ob<∞”. In addition, the regression model is not limited to the CNN, and various machine learning models can be applied.

The variable conversion unit 24 performs variable conversion on the estimated value Oa of the number of seconds and the score value Ob of the certainty according to the following Expressions (1) and (2) to generate parameters and b of a probability distribution model, respectively.

$$μ = Oa \qquad ( 1 )$$

$$b = 1 / log ( 1 + exp ( - Ob ) ) \qquad ( 2 )$$

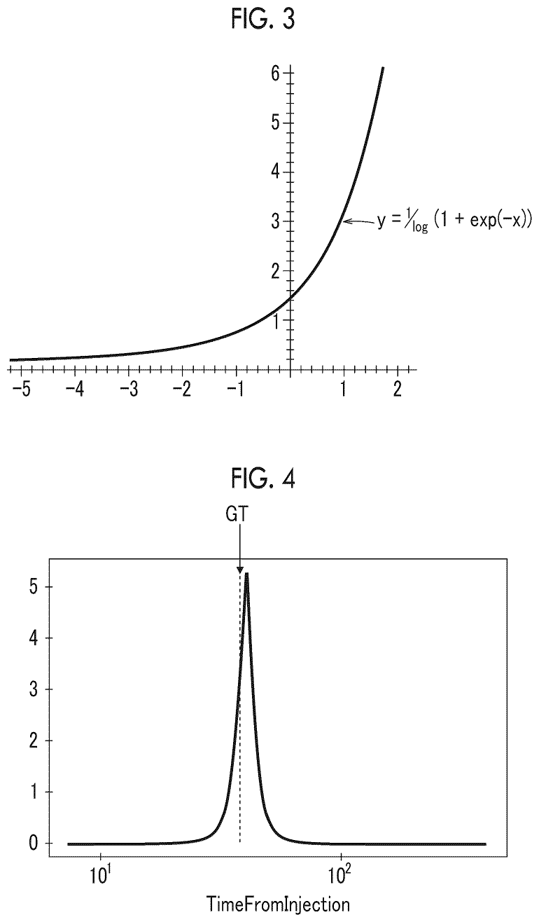

The function represented by Expression (2) is an example of mapping that converts the score value Ob of the certainty into a value b in a positive region. FIG. 3 is a graph of a function y=1/log(1+exp(−x)) used for the variable conversion represented by Expression (2). The parameter μ is an example of a “first parameter” according to the present disclosure. The parameter b is an example of a “second parameter” according to the present disclosure.

In the first embodiment, the Laplace distribution is applied as the probability distribution model of the number-of-seconds distribution. The Laplace distribution is represented by a function represented by the following Expression (3).

$$f ( x ; μ , b ) = \frac{1}{2 b} exp ( - \frac{\vert x - μ \vert}{b} ) \qquad ( 3 )$$

The reason for converting the score value Ob of the certainty into the positive value b is related to the application of the Laplace distribution as the probability distribution model of the number-of-seconds distribution. The reason is that, in a case where the parameter b is a negative value (b<0), the Laplace distribution is not established as the probability distribution, and thus it is necessary to ensure that the parameter b is a positive value (b>0).

FIG. 4 illustrates an example of a graph of the number-of-seconds distribution that is estimated on the basis of the parameters and b estimated by the number-of-seconds distribution estimation unit 14. In addition, a position indicated by a broken line GT in FIG. 4 corresponds to a correct number of seconds (correct answer number of seconds). Estimating a set of the estimated value Oa and the score value Ob of the certainty from the input images IM substantially corresponds to estimating the number-of-seconds distribution. The estimated value Oa of the number of seconds is an example of a “random variable” according to the present disclosure.

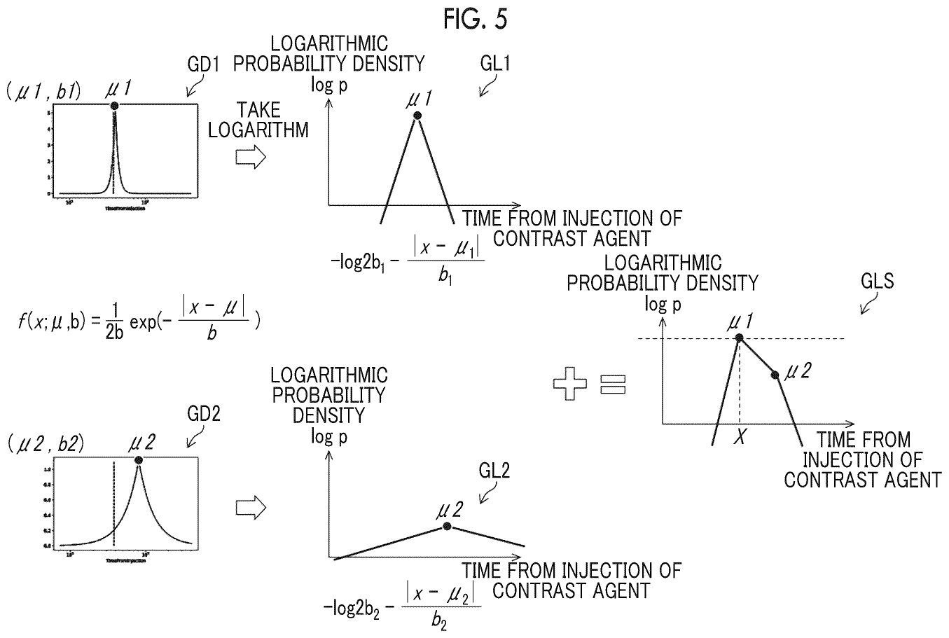

FIG. 5 is a diagram illustrating an example of the processes of the integration unit 16 and the maximum point specification unit 18. Here, for simplicity of description, an example in which two number-of-seconds distributions estimated by the number-of-seconds distribution estimation unit 14 are integrated will be described. However, the same applies to a case where three or more number-of-seconds distributions are integrated.

A graph GD1 illustrated on the upper left side of FIG. 5 is an example of a number-of-seconds distribution (probability distribution P1) represented by parameters μ1 and b1 estimated for the input of the image IM1 (not illustrated in FIG. 5) by the number-of-seconds distribution estimation unit 14. The integration unit 16 takes a logarithm of the estimated number-of-seconds distribution to convert the number-of-seconds distribution into a logarithmic probability density and calculates the sum of a plurality of logarithmic probability densities to perform integration. This corresponds to calculating the product of the probabilities at the same number of seconds.

A graph GL1 illustrated in FIG. 5 is an example of a logarithmic probability density log P1 obtained by taking a logarithm of the probability distribution P1. A graph GD2 illustrated on the lower left side of FIG. 5 is an example of a number-of-seconds distribution (probability distribution P2) represented by parameters μ2 and b2 estimated for the input of the image IM2 (not illustrated in FIG. 5) by the number-of-seconds distribution estimation unit 14. A graph GL2 illustrated in FIG. 5 is an example of a logarithmic probability density log P2 obtained by taking a logarithm of the probability distribution P2.

A graph GLS illustrated on the rightmost side of FIG. 5 is an example of a simultaneous logarithmic probability density obtained by integrating the logarithmic probability density log P1 and the logarithmic probability density log P2. The distribution illustrated in the graph GLS is an example of an “integrated distribution” according to the present disclosure.

The maximum point specification unit 18 specifies a value x of the parameter μ, at which the logarithmic probability is maximized, from the integrated logarithmic probability density. The process of the maximum point specification unit 18 can be represented by the following Expression (4).

$$\begin{matrix}x = {arg max}_{x} {\sum }_{i} ( - log 2 {b}_{i} - \frac{\vert x - {μ}_{i} \vert}{{b}_{i}} ) \\ = {arg min}_{x} {\sum }_{i} ( log {b}_{i} + \frac{\vert x - {μ}_{i} \vert}{{b}_{i}} ) \\ = {arg min}_{x} {\sum }_{i} \frac{\vert x - {μ}_{i} \vert}{{b}_{i}}\end{matrix} \qquad ( 4 )$$

A target function of arg min (a portion after X) illustrated on the right side of an equal sign described in the second row of Expression (4) corresponds to a loss function during training in machine learning which will be described below. In addition, the right side of the equal sign described in the third row corresponds to a weighted median expression. A parameter bi corresponding to the weight during integration dynamically changes according to the output of the regression estimation unit 22.

In the case of the integrated logarithmic probability density illustrated in the graph GLS of FIG. 5, the input value (maximum point) at which the simultaneous logarithmic probability is maximized is μl, and μl is selected as the final estimation result (final result). In addition, μl is the estimation result for the image IM1 among the plurality of input slice images. In FIG. 5, the number-of-seconds distribution is converted into the logarithmic probability density, and calculation is performed. In short, a process that derives a value, at which the simultaneous probability is maximized, as the final result, considering the simultaneous probability of a plurality of number-of-seconds distributions (probability distributions) estimated from a plurality of different inputs is performed.

The Laplace distribution is adopted as the probability distribution model, and the integrated distribution (simultaneous probability distribution) has the form of a weighted median. Therefore, in a case where some of a plurality of estimation results are values that deviate significantly due to artifacts or the like, it is possible to suppress the influence of the outliers and to obtain an estimated value with high accuracy.

### <<Description of Medical Image Used for Input>>

In a digital imaging and communications in medicine (DICOM) standard that defines a format of a medical image and a communication protocol, a series ID is defined in a unit called a study ID which is an identification code (ID) for identifying an examination type.

For example, in the liver contrast imaging of a certain patient, CT imaging is performed a plurality of times (here, four times) in a range including the liver while changing the imaging timing as described below.
[First imaging] Before the injection of the contrast agent
[Second imaging] 35 seconds after the injection of the contrast agent
[Third imaging] 70 seconds after the injection of the contrast agent
[Fourth imaging] 180 seconds after the injection of the contrast agent

Four types of CT data are obtained by the four imaging operations. The term “CT data” referred to here is three-dimensional data that is composed of a plurality of consecutive slice images (tomographic images), and an aggregate of the plurality of slice images constituting the three-dimensional data (a group of consecutive slice images) is referred to as an “image series”. The CT data is an example of a “three-dimensional image” according to the present disclosure.

The same study ID and different series IDs are given to the four types of CT data obtained by a series of imaging operations including the four imaging operations.

For example, “study 1” is given as a study ID for an examination of liver contrast imaging on a specific patient, and a unique ID is given to each series as follows: “series 1” is given as a series ID for CT data obtained by imaging before the injection of the contrast agent; “series 2” is given to CT data obtained by imaging 35 seconds after the injection of the contrast agent; “series 3” is given to CT data obtained by imaging 70 seconds after the injection of the contrast agent; and “series 4” is given to CT data obtained by imaging 180 seconds after the injection of the contrast agent. Therefore, the CT data can be identified by combining the study ID and the series ID. Meanwhile, in some cases, in the actual CT data, the correspondence relationship between the series ID and the imaging timing (elapsed time since the injection of the contrast agent) is not clearly understood.

In addition, since the size of the three-dimensional CT data is large, it may be difficult to perform, for example, the process of estimating the number of seconds using the CT data as input data without any change. In the first embodiment, the number of seconds is estimated by image analysis, using a plurality of slice images in the same series as an input. The term “by image analysis” means by a process based on pixel values constituting image data.

### Example 1 of Machine Learning Method

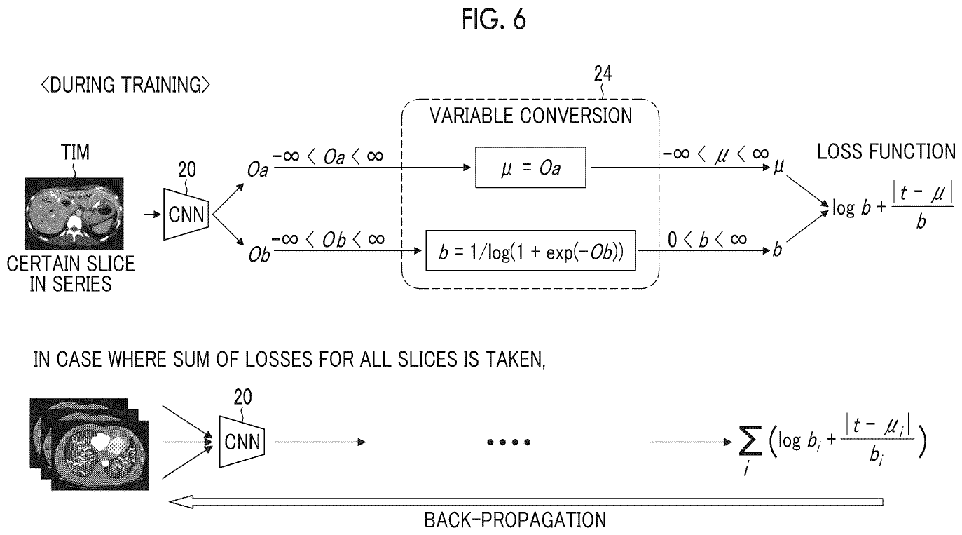

FIG. 6 is a diagram schematically illustrating an example of a machine learning method for generating a regression model applied to the number-of-seconds distribution estimation unit 14. Training data used for machine learning includes an image TIM as data for input and a correct answer data (teaching signal t) corresponding to the input. The image TIM may be a slice image constituting an image series of three-dimensional CT data, and the teaching signal t may be a value indicating the number of seconds (ground truth) from the injection of the contrast agent in a case where the series to which the slice image belongs is captured.

For example, a plurality of training data items are generated by linking the corresponding teaching signals t to all of the slices the image series. The “linking” may be paraphrased as correspondence or association. The term “training” is synonymous with “learning”. The same teaching signal t may be linked to the slices of the same image series. That is, the teaching signal t may be linked in units of image series. For a plurality of image series, similarly, a plurality of training data items are generated by linking the corresponding teaching signals t to the slices. An aggregate of the plurality of training data items generated in this way is used as a training data set.

A learning model 20 is configured using the CNN. The learning model 20 is used in combination with a variable conversion unit 24. In addition, the variable conversion unit 24 may be integrally incorporated into the learning model 20.

In a case where the image TIM read out from the training data set is input to the learning model 20, the learning model 20 outputs the estimated value Oa of the number of seconds and the score value Ob of the certainty of the estimated value Oa. The variable conversion unit 24 performs variable conversion to convert the estimated value Oa and the score value Ob into a parameter p and a parameter b of the probability distribution model, respectively.

A loss function L used during training is defined by the following Expression (5).

$$L = log b + \frac{\vert t - μ \vert}{b} \qquad ( 5 )$$

As illustrated on the lower side of FIG. 6, in a case where the sum of losses for all of slices of the same image series is taken, the sum is represented by the following Expression (6).

$${\sum }_{i} ( log {b}_{i} + \frac{\vert t - {μ}_{i} \vert}{{b}_{i}} ) \qquad ( 6 )$$

A suffix i is an index for identifying each slice. A back-propagation method is applied using the sum of the losses represented by Expression (6), and the learning model 20 is trained (the parameters of the learning model 20 are updated) using a stochastic gradient descent method in the same manner as in normal CNN training. The sum of the losses calculated by Expression (6) is an example of a “calculation result of a loss function” according to the present disclosure. The learning model 20 is trained using a plurality of training data items including a plurality of image series such that the parameters of the learning model 20 are optimized to obtain a trained model. The trained model obtained in this way is applied as the regression model of the number-of-seconds distribution estimation unit 14.

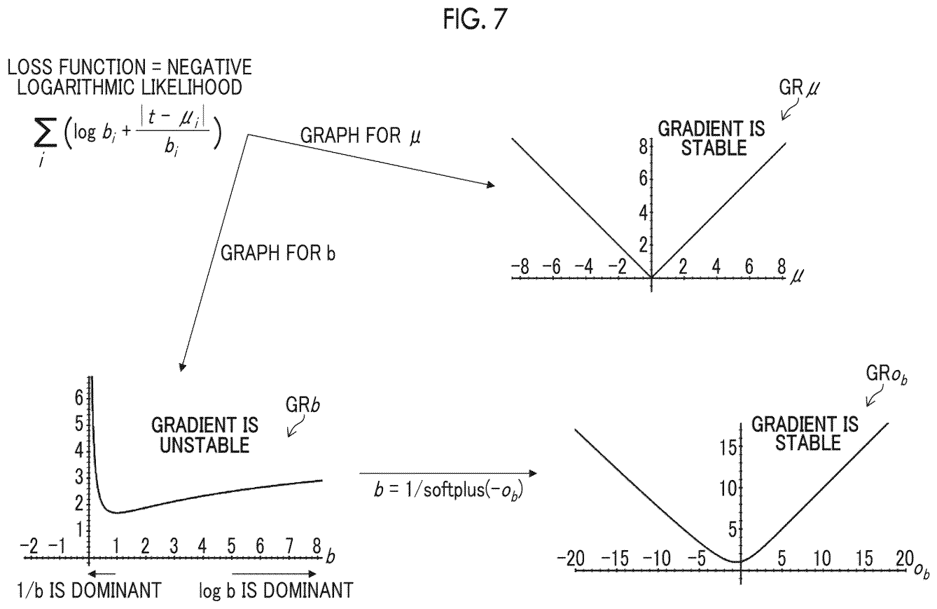

FIG. 7 is a diagram illustrating the loss function used during training. The loss function is negative logarithmic likelihood and directly optimizes an expression that is used for regression estimation using learning. The logarithmic likelihood of the teaching signal t at the number of seconds is optimized by learning. A graph for the parameter of the loss function represented by Expression (5) is a graph GR in FIG. 7. In the graph GR, the gradient with respect to the parameter is stable.

On the other hand, a graph for the parameter b of the loss function represented by Expression (5) is a graph GRb in FIG. 7. In the graph GRb, the gradient with respect to the parameter b is unstable. 1/b is dominant in a region in which the value of b is small, and log b is dominant in a region in which the value of b is large.

The graph GRb in which the gradient is unstable is converted into a graph GROb by performing variable conversion to convert the parameter b using a function such as b=1/softplus(−Ob). A softplus function is defined as softplus(x)=log(1+exp(x)). The function used for the variable conversion of the parameter b is a function that approaches −1/x at x→−∞ and approaches exp(x) at x→∞. The use of this function makes it possible to cancel the instability of the gradient.

The machine learning method of the learning model 20 described with reference to FIGS. 6 and 7 is an example of a “method for generating a trained model” according to the present disclosure.

### Example of Hardware Configuration

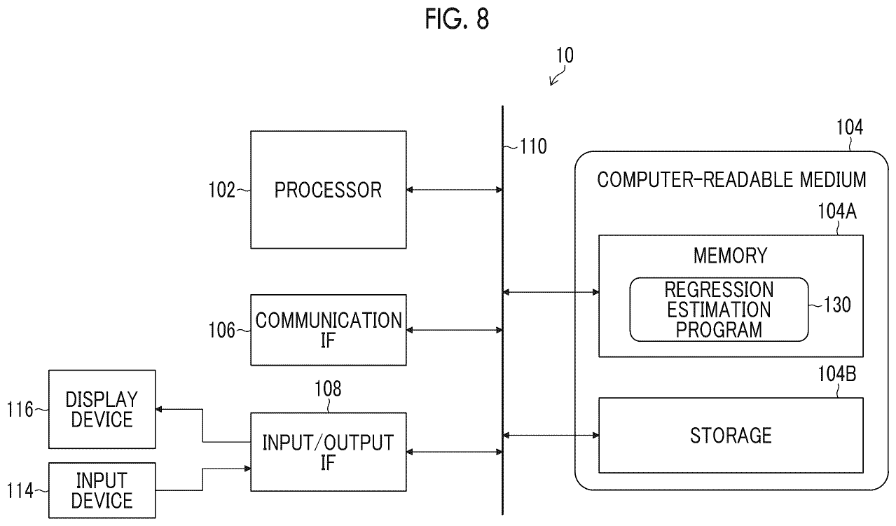

FIG. 8 is a block diagram schematically illustrating an example of a hardware configuration of the regression estimation device 10 according to the first embodiment. The regression estimation device 10 can be implemented by a computer system that is configured using one or a plurality of computers. Here, an example in which one computer executes a program to implement various functions of the regression estimation device 10 will be described. In addition, the form of the computer that functions as the regression estimation device 10 is not particularly limited, and the computer may be, for example, a server computer, a workstation, a personal computer, or a tablet terminal.

The regression estimation device 10 includes a processor 102, a computer-readable medium 104 which is a non-transitory tangible object, a communication interface 106, an input/output interface 108, and a bus 110.

The processor 102 includes a central processing unit (CPU). The processor 102 may include a graphics processing unit (GPU). The processor 102 is connected to the computer-readable medium 104, the communication interface 106, and the input/output interface 108 through the bus 110. The processor 102 reads out various programs, data, and the like stored in the computer-readable medium 104 and executes various processes.

The computer-readable medium 104 includes, for example, a memory 104A which is a main storage device and a storage 104B which is an auxiliary storage device. The storage 104B is configured using, for example, a hard disk drive (HDD) device, a solid state drive (SSD) device, an optical disk, a magneto-optical disk, a semiconductor memory, or an appropriate combination thereof. The storage 104B stores, for example, various types of programs or data. The computer-readable medium 104 is an example of a “storage device” according to the present disclosure.

The memory 104A is used as a work area of the processor 102 and is used as a storage unit that temporarily stores the program and various types of data read out from the storage 104B. The program stored in the storage 104B is loaded to the memory 104A, and the processor 102 executes commands of the program to function as units for performing various processes defined by the program. The memory 104A stores, for example, a regression estimation program 130 executed by the processor 102 and various types of data. The regression estimation program 130 includes a trained model that has been trained by machine learning and causes the processor 102 to perform the processes described with reference to FIG. 1.

The communication interface 106 performs a wired or wireless communication process with an external device to exchange information with the external device. The regression estimation device 10 is connected to a communication line (not illustrated) via the communication interface 106. The communication line may be a local area network or a wide area network. The communication interface 106 can play a role of a data acquisition unit that receives the input of data such as an image.

The regression estimation device 10 may further include an input device 114 and a display device 116. The input device 114 and the display device 116 are connected to the bus 110 via the input/output interface 108. The input device 114 may be, for example, a keyboard, a mouse, a multi-touch panel, other pointing devices, a voice input device, or an appropriate combination thereof.

The display device 116 is an output interface on which various types of information are displayed. The display device 116 may be, for example, a liquid crystal display, an organic electro-luminescence (OEL) display, a projector, or an appropriate combination thereof.

### <<Functional Configuration of Regression Estimation Device 10>>

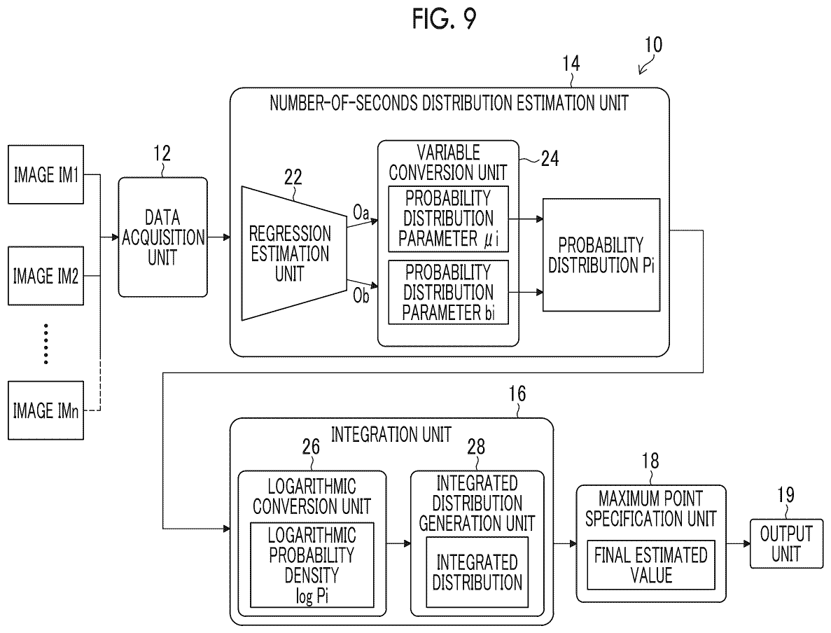

FIG. 9 is a functional block diagram illustrating an outline of processing functions of the regression estimation device 10 according to the first embodiment. The processor 102 of the regression estimation device 10 executes the regression estimation program 130 stored in the memory 104A to function as the data acquisition unit 12, the number-of-seconds distribution estimation unit 14, the integration unit 16, the maximum point specification unit 18, and the output unit 19.

The data acquisition unit 12 receives the input of data to be processed. In the example illustrated in FIG. 9, the data acquisition unit 12 acquires the images IMi which are the slice images sampled from CT data. A subscript i (where i=1 to n) indicates an index number for identifying a plurality of images. FIG. 9 illustrates that n different images can be input. n may be an integer equal to or greater than 2. The data acquisition unit 12 may perform a process of cutting out slice images from the CT data at equal intervals or may acquire the slice images sampled in advance using a processing unit (not illustrated) or the like.

The images IMi acquired through the data acquisition unit 12 are input to the regression estimation unit 22 of the number-of-seconds distribution estimation unit 14. The regression estimation unit 22 outputs a set of the estimated value Oa of the number of seconds and the score value Ob indicating the certainty of the estimated value Oa from each of the input images IMi.

The variable conversion unit 24 converts the estimated value Oa output from the regression estimation unit 22 into a parameter i of the probability distribution model. The variable conversion unit 24 converts the score value Ob of the certainty output from the regression estimation unit 22 into a parameter bi of the probability distribution model. A probability distribution Pi of the number of seconds is estimated by these two parameters μi and bi.

A plurality of images IMi (i=1 to n) in the same series are input, and a set of the estimated value Oa and the score value Ob is estimated for each of the images IMi and is converted into a set of the parameters μi and bi. Then, the probability distribution Pi of the number of seconds is estimated. A plurality of sets of the estimated value Oa and the score value Ob estimated from each of the images IMi are an example of “a plurality of sets of estimation results” according to the present disclosure.

The integration unit 16 performs a process of integrating a plurality of probability distributions Pi obtained on the basis of the input of the plurality of images IMi. In FIG. 9, a logarithmic conversion unit 26 takes a logarithm of the probability distribution Pi to convert the probability distribution Pi into a logarithmic probability density log Pi, and an integrated distribution generation unit 28 calculates the sum of the logarithmic probability densities log Pi to obtain an integrated distribution.

The maximum point specification unit 18 specifies the value of the number of seconds (maximum point), at which the probability is maximized, from the integrated distribution and outputs the specified value of the number of seconds as a final estimated value. In addition, the maximum point specification unit 18 may be incorporated into the integration unit 16.

The output unit 19 is an output interface for displaying the final estimated value specified by the maximum point specification unit 18 or for providing the final estimated value to other processing units. The output unit 19 may include a processing unit that performs, for example, a process of generating data for display and/or a data conversion process for transmission of data to the outside or the like. The number of seconds estimated by the regression estimation device 10 may be displayed on a display device (not illustrated) or the like.

Further, the contrast state may be estimated from the number of seconds estimated by the regression estimation device 10, and the estimation result of the classification of the contrast state may be displayed on the display device or the like, instead of the number of seconds or together with the number of seconds. For example, in the case of a CT image obtained by imaging the liver, the classification of the contrast state includes four phases (categories) of a non-contrast phase (before the injection of the contrast agent), an arterial phase, a portal phase, and an equilibrium phase. A configuration can also be adopted in which the contrast state is estimated from the number of seconds using, for example, a table that defines a correspondence relationship between the number of seconds output from the regression estimation device 10 and the classification of the contrast state.

The regression estimation device 10 may be incorporated into a medical image processing device for processing a medical image acquired in a medical institution such as a hospital. In addition, the processing functions of the regression estimation device 10 may be provided as a cloud service. The method of the regression estimation process executed by the processor 102 is an example of a “regression estimation method” according to the present disclosure.

### Second Embodiment

In the first embodiment, the Laplace distribution is used as the probability distribution model of the number-of-seconds distribution. However, the present invention is not limited thereto, and other probability distribution models may be applied. In a second embodiment, an example will be described in which a Gaussian distribution is used instead of the Laplace distribution.

A regression estimation device 10 according to the second embodiment may have the same hardware configuration as that according to the first embodiment. Differences of the second embodiment from the first embodiment will be described. The second embodiment is different from the first embodiment in the content of the processes of the processing units of the number-of-seconds distribution estimation unit 14, the integration unit 16, and the maximum point specification unit 18.

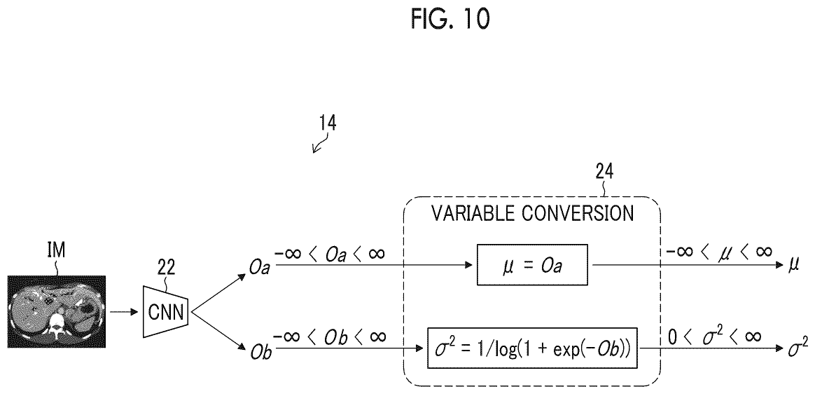

FIG. 10 is a diagram illustrating Example 2 of the process of the number-of-seconds distribution estimation unit 14 in the regression estimation device 10 according to the second embodiment. A process illustrated in FIG. 10 is applied instead of the process described with reference to FIG. 2.

The variable conversion unit 24 according to the second embodiment converts the score value Ob of the certainty into a parameter σ² using the following Expression (7) instead of Expression (2).

$${σ}^{2} = 1 / log ( 1 + exp ( - Ob ) ) \qquad ( 7 )$$

σ² plays a role of certainty. σ² corresponds to a dispersion, and a corresponds to a standard deviation.

The Gaussian distribution is represented by a function represented by the following Expression (8).

$$f ( x ; μ , σ ) = \frac{1}{\sqrt{2 π {σ}^{2}}} exp ( - \frac{{( x - μ )}^{2}}{2 {σ}^{2}} ) \qquad ( 8 )$$

The reason for converting the score value Ob into a positive value (σ²) is the same as that in the first embodiment. The reason is that, in a case where the parameter σ² is a negative value, the Gaussian distribution is not established as the probability distribution and it is necessary to ensure that the parameter σ² is a positive value (σ²>0).

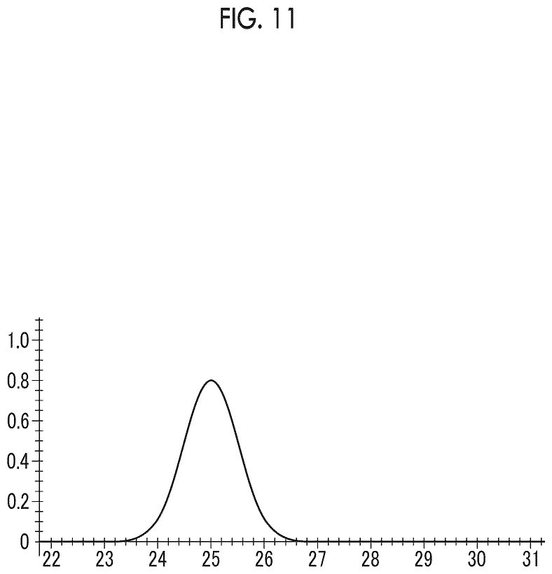

FIG. 11 illustrates an example of a graph of the number-of-seconds distribution that is estimated on the basis of the parameters μ and σ² estimated by the number-of-seconds distribution estimation unit 14.

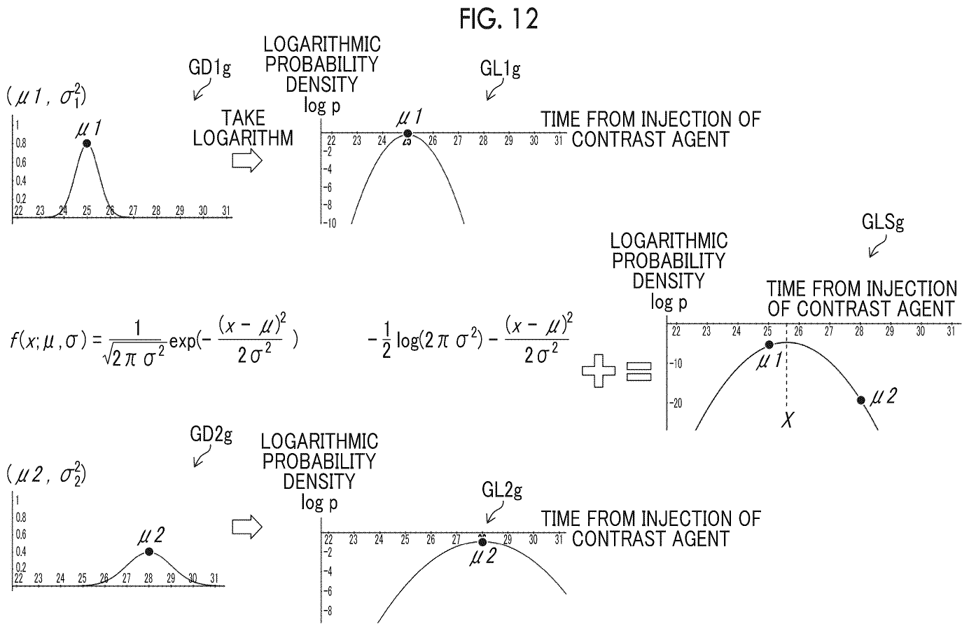

FIG. 12 is a diagram illustrating an example of processes of the integration unit 16 and the maximum point specification unit 18 of the regression estimation device 10 according to the second embodiment. Here, an example in which two number-of-seconds distributions estimated by the number-of-seconds distribution estimation unit 14 are integrated will be described.

A graph GD1g illustrated on the upper left side of FIG. 12 is an example of the number-of-seconds distribution (probability distribution P1) represented by parameters μ1 and σ²₁ estimated by the number-of-seconds distribution estimation unit 14 illustrated in FIG. 10. The integration unit 16 takes a logarithm of the estimated number-of-seconds distribution to convert the number-of-seconds distribution into a logarithmic probability density and calculates the sum of a plurality of logarithmic probability densities to perform integration. This corresponds to calculating the product of the probabilities at the same number of seconds.

A graph GL1g illustrated in FIG. 12 is an example of a logarithmic probability density log P1 obtained by taking a logarithm of the probability distribution P1. A graph GD2g illustrated on the lower left side of FIG. 12 is an example of the number-of-seconds distribution (probability distribution P2) represented by parameters μ2 and σ²₂ estimated by the number-of-seconds distribution estimation unit 14. A graph GL2g illustrated in FIG. 12 is an example of a logarithmic probability density log P2 obtained by taking a logarithm of the probability distribution P2.

A graph GLSg illustrated on the rightmost side of FIG. 12 is an example of a simultaneous logarithmic probability density obtained by integrating the logarithmic probability density log P1 and the logarithmic probability density log P2.

The maximum point specification unit 18 specifies a value x, at which the logarithmic probability is maximized, from the integrated simultaneous logarithmic probability density. The process of the maximum point specification unit 18 can be represented by the following Expression (9).

$$\begin{matrix}x = {arg max}_{x} {\sum }_{i} ( - log 2 π {σ}_{i}^{2} - \frac{{( x - {μ}_{i} )}^{2}}{2 {σ}^{2}} ) \\ = {arg min}_{x} {\sum }_{i} ( log {σ}_{i}^{2} + \frac{{( x - {μ}_{i} )}^{2}}{2 {σ}^{2}} ) \\ = {arg min}_{x} {\sum }_{i} \frac{{( x - {μ}_{i} )}^{2}}{{σ}^{2}}\end{matrix} \qquad ( 9 )$$

A target function of arg min (a portion after Σ) illustrated on the right side of an equal sign described in the second row of Expression (9) corresponds to a loss function during training in machine learning which will be described below. In addition, the right side of the equal sign described in the third row corresponds to a weighted average expression.

In the case of the integrated logarithmic probability density in the graph GLSg illustrated in FIG. 12, the input value x (maximum point) at which the logarithmic probability is maximized is selected as the final estimation result (final result).

### Example 2 of Machine Learning Method

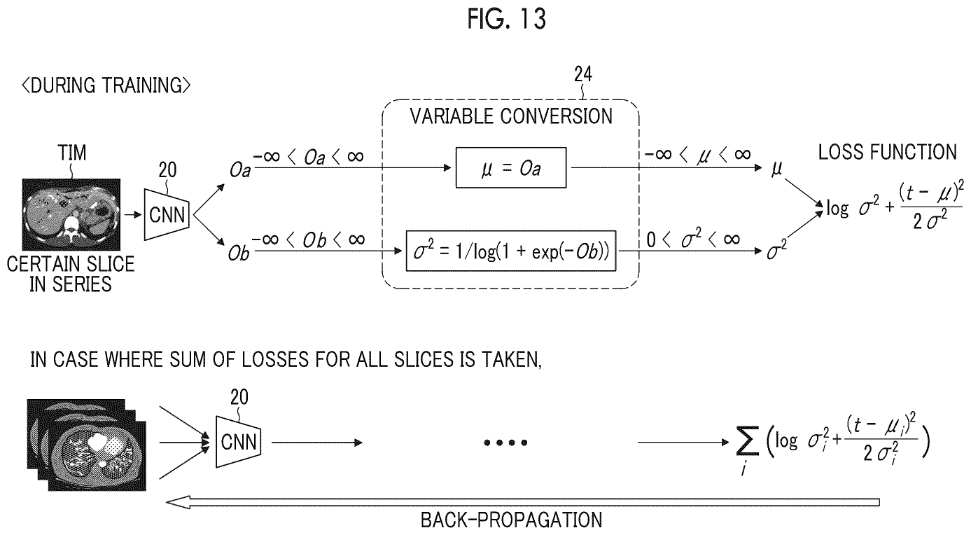

FIG. 13 is a diagram schematically illustrating an example of a machine learning method for generating a regression model applied to the number-of-seconds distribution estimation unit 14 according to the second embodiment. Training data used for learning may be the same as that in the first embodiment. Differences from FIG. 6 will be described with reference to FIG. 13.

In a case where the image TIM read out from the training data set is input to the learning model 20, the learning model 20 outputs the estimated value Oa of the number of seconds and the score value Ob of the certainty of the estimated value Oa. The variable conversion unit 24 performs variable conversion to convert the estimated value Oa and the score value Ob of the certainty into parameters μ and σ² of the probability distribution model, respectively.

A loss function L during training is defined by the following Expression (10).

$$L = log {σ}^{2} + \frac{{( t - μ )}^{2}}{2 {σ}^{2}} \qquad ( 10 )$$

As illustrated on the lower side of FIG. 13, in a case where the sum of losses is taken for all of slices of the same image series, the sum is represented by the following Expression (11).

$${\sum }_{i} ( log {σ}_{i}^{2} + \frac{{( t - {μ}_{i} )}^{2}}{2 {σ}_{i}^{2}} ) \qquad ( 11 )$$

The back-propagation method is applied using the sum of the losses represented by Expression (11), and the learning model 20 is trained using the stochastic gradient descent method in the same manner as in normal CNN training. The learning model 20 is trained using a plurality of training data items including a plurality of image series such that the parameters of the learning model 20 are optimized to obtain a trained model. The trained model obtained in this way is applied to the number-of-seconds distribution estimation unit 14.

### Modification Example 1

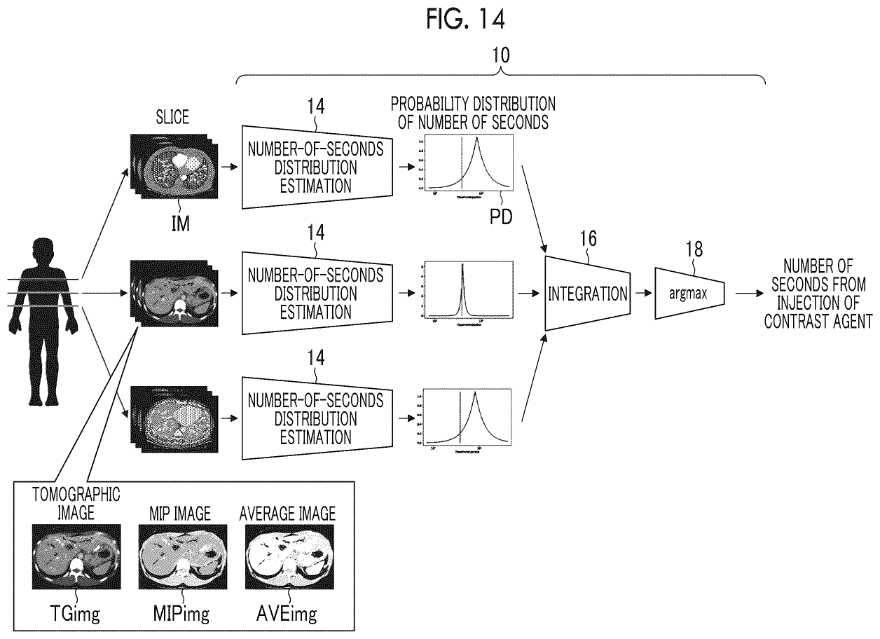

In the first embodiment and the second embodiment, the slice images (tomographic images) obtained by dividing three-dimensional CT data into slices at equal intervals are used as the input. However, the image to be processed is not limited thereto. For example, as illustrated in FIG. 14, instead of the tomographic image TGimg, the image may be a maximum intensity projection (MIP) image MIPimg configured at equal intervals, an average image AVEimg generated from a plurality of slice images, or the like. Further, the data used for the input is not limited to the two-dimensional image and may be a three-dimensional image (three-dimensional data). For example, three-dimensional partial images at different positions in the same series may be used as the input.

### Modification Example 2

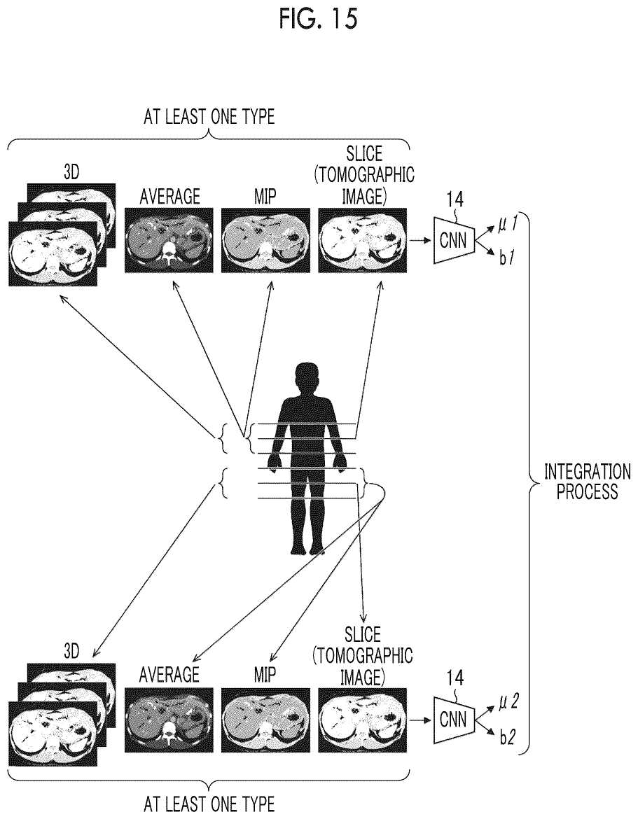

The input to the number-of-seconds distribution estimation unit 14 may be a combination of a plurality of types of data elements. For example, as illustrated in FIG. 15, at least one of the three-dimensional image (a set of a plurality of slice images), the slice image, the MIP image, or the average image which is a partial image of CT data of the same image series can be used as the input. A combination of the plurality of types of images may be input to the number-of-seconds distribution estimation unit 14 to obtain an output of the estimated value of the number of seconds and the certainty thereof. For example, a combination of the average image and the MIP image may be input to the number-of-seconds distribution estimation unit 14 to estimate the number-of-seconds distribution. The MIP image and the average image are examples of a generated image that is generated from partial images of three-dimensional CT data.

### Example of Configuration of Medical Information System

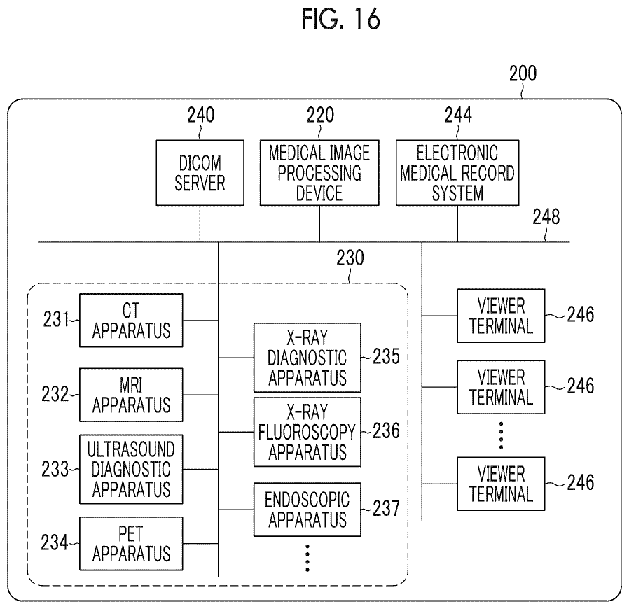

FIG. 16 is a block diagram illustrating an example of a configuration of a medical information system 200 including a medical image processing device 220. The regression estimation device 10 described in the first and second embodiments is incorporated into, for example, the medical image processing device 220. The medical information system 200 is a computer network constructed in a medical institution such as a hospital. The medical information system 200 includes a modality 230 that captures a medical image, a DICOM server 240, the medical image processing device 220, an electronic medical record system 244, and a viewer terminal 246. These elements are connected via a communication line 248. The communication line 248 may be a local communication line in the medical institution. Further, a portion of the communication line 248 may be a wide area communication line.

Specific examples of the modality 230 include a CT apparatus 231, a magnetic resonance imaging (MRI) apparatus 232, an ultrasound diagnostic apparatus 233, a positron emission tomography (PET) apparatus 234, an X-ray diagnostic apparatus 235, an X-ray fluoroscopy apparatus 236, and an endoscopic apparatus 237. There may be various combinations of types of the modalities 230 connected to the communication line 248 for each medical institution.

The DICOM server 240 is a server that operates according to the specifications of DICOM. The DICOM server 240 is a computer that stores various types of data including the images captured by the modality 230 and that manages various types of data and comprises a large-capacity external storage device and a database management program. The DICOM server 240 communicates with other devices through the communication line 248 to transmit and receive various types of data including image data. The DICOM server 240 receives the image data generated by the modality 230 and other various types of data through the communication line 248, stores the data in a recording medium, such as a large-capacity external storage device, and manages the data. In addition, the storage format of the image data and the communication between the devices via the communication line 248 are based on a DICOM protocol.

The medical image processing device 220 can acquire data from the DICOM server 240 or the like via the communication line 248. The medical image processing device 220 performs image analysis and various other types of processes on the medical images captured by the modality 230. The medical image processing device 220 may be configured to perform, for example, various analysis processes, such as computer aided diagnosis and computer aided detection (CAD), including a process of recognizing a lesion region or the like from an image, a process of specifying a classification, such as a disease name, and a segmentation process of recognizing a region of an organ or the like, in addition to the processing functions of the regression estimation device 10. Further, the medical image processing device 220 can transmit a processing result to the DICOM server 240 and the viewer terminal 246. Furthermore, the processing functions of the medical image processing device 220 may be provided in the DICOM server 240 or the viewer terminal 246.

The various types of data stored in a database of the DICOM server 240 and various types of information including processing results generated by the medical image processing device 220 can be displayed on the viewer terminal 246.

The viewer terminal 246 is a terminal for image viewing called a picture archiving and communication systems (PACS) viewer or a DICOM viewer. A plurality of viewer terminals 246 may be connected to the communication line 248. The form of the viewer terminal 246 is not particularly limited and may be, for example, a personal computer, a workstation, or a tablet terminal.

### <<For Program for Operating Computer>>

A program that causes a computer to implement the processing functions of the regression estimation device 10 can be recorded on a computer-readable medium which is a non-transitory tangible information storage medium, such as an optical disk, a magnetic disk, or a semiconductor memory. Then, the program can be provided through the information storage medium.

Further, instead of the aspect in which the program is stored in the non-transitory tangible computer-readable medium and then provided, program signals may be provided as a download service using a telecommunication line such as the Internet.

Further, some or all of the processing functions of the regression estimation device 10 may be implemented by cloud computing or may be provided as a Software as a Service (SasS) service.

<<For Hardware Configuration of Each Processing Unit>>

A hardware structure of processing units performing various processes, such as the data acquisition unit 12, the number-of-seconds distribution estimation unit 14, the integration unit 16, the maximum point specification unit 18, the output unit 19, the regression estimation unit 22, the variable conversion unit 24, the logarithmic conversion unit 26, and the integrated distribution generation unit 28, in the regression estimation device 10 is, for example, the following various processors.

The various processors include, for example, a CPU which is a general-purpose processor executing a program to function as various processing units, a GPU which is a processor specializing in image processing, a programmable logic device (PLD), such as a field programmable gate array (FPGA), which is a processor whose circuit configuration can be changed after manufacture, and a dedicated electric circuit, such as an application specific integrated circuit (ASIC), which is a processor having a dedicated circuit configuration designed to perform a specific process.

One processing unit may be configured by one of the various processors or a combination of two or more processors of the same type or different types. For example, one processing unit may be configured by a plurality of FPGAs, a combination of a CPU and an FPGA, or a combination of a CPU and a GPU. In addition, a plurality of processing units may be configured by one processor. A first example of the configuration in which a plurality of processing units are configured by one processor is an aspect in which one processor is configured by a combination of one or more CPUs and software and functions as a plurality of processing units. A representative example of this aspect is a client computer or a server computer. A second example of the configuration is an aspect in which a processor that implements the functions of the entire system including a plurality of processing units using one integrated circuit (IC) chip is used. A representative example of this aspect is a system-on-chip (SoC). As described above, various processing units are configured using one or more of the various processors as a hardware structure.

In addition, specifically, the hardware structure of the various processors is an electric circuit (circuitry) obtained by combining circuit elements such as semiconductor elements.

### Advantages of This Embodiment

According to the first embodiment and the second embodiment, the following advantages are achieved.

<1> The estimation results corresponding to a plurality of inputs can be weighted and integrated. Therefore, it is possible to reduce the influence of an image in which it is difficult to estimate the number of seconds (for example, an image that includes an artifact and makes it difficult to perform scene analysis) and to obtain an estimated value with high accuracy. For example, in a case where data that is inappropriate for estimation is input as one of the inputs, even though the estimated value corresponding to the input deviates significantly, the certainty is reduced, and the influence on the integration result is suppressed.

<2> The expression used for inference of the regression model can be directly optimized by machine learning.

<3> The number of seconds with a high certainty factor can be estimated by the image analysis of the input image. Therefore, it is possible to estimate the number of seconds with a high certainty factor even for an image in which accessory information related to the imaging time is not recorded on a DICOM tag, an image in which erroneous time information or the like is recorded, or the like.

<4> It may be difficult to input three-dimensional CT data to the regression model at once and to process the three-dimensional CT data in terms of size. However, as described in the first embodiment and the second embodiment, two-dimensional images, such as slice images, which are a portion of three-dimensional CT data are sequentially processed, and the estimation results for the images are integrated, which makes it possible to derive an appropriate estimated value from the entire input data.

Further, the following advantages are obtained by adopting the Laplace distribution as the probability distribution model as described in the first embodiment.

<5> Learning is stable and is robust to label noise to some extent.

<6> Further, the simultaneous probability distribution has the form of a weighted median. In a case where one of the estimation results for some of the inputs deviates significantly due to artifacts or the like, learning is less likely to be affected by the outlier and is further robust.

<7> Furthermore, it is possible to extract an image used for the final result (estimation of the final estimated value) from a plurality of images used for input.

### Other Application Examples

The technology of the present disclosure can be applied to various purposes, and there may be various aspects for the type of data used for input and an objective variable to be estimated. The technology of the present disclosure can be applied to, for example, the following problem of regression estimation.

### Application Example 1: Problem of Performing Regression Using Plurality of Slice Images

Specifically, the technology of the present disclosure can be applied to the task of recognizing the position of a target organ in a three-dimensional direction from a plurality of slice images (two-dimensional images), in addition to the task of estimating the elapsed time from the injection of the contrast agent as described in the first embodiment and the second embodiment. For example, the technology of the present disclosure can be applied to a process of regressively estimating the coordinates of a rectangular parallelepiped (three-dimensional bounding box) indicating the position of an organ from a plurality of slice images in the same series. The organ referred to here is an example of a “specific object” in the present disclosure, and the coordinates of the bounding box are an example of a “value indicating a position of a specific object” in the present disclosure.

In addition, the technology of the present disclosure can be applied to a process of estimating a slice position (a position in CT data) for an input slice image. The slice position referred to here is an example of a “position of a partial image” in the present disclosure.

### Application Example 2: Problem of Performing Regression on Input of Time-Series Image, Such as Video Image, or Plurality of Images

Specifically, the technology of the present disclosure can be applied to, for example, a process of estimating an age of a person included in an image such as a video image. Further, the technology of the present disclosure can also be applied to a regression estimation process in a case where scene recognition is performed on an image such as a video image.

### Application Example 3: Problem of Performing Regression from Sound Data

Specifically, the technology of the present disclosure can be applied to, for example, a regression estimation process in a case where emotion is recognized from voice.

### Application Example 4: Problem of Regressing One Value from Plurality of Resolutions

Specifically, for example, the technology of the present disclosure can be applied to a process of regressively estimating the position of a bounding box for object detection from a plurality of images having different resolutions.

### <<Others>>

The present disclosure is not limited to the above-described embodiments, and various modifications can be made without departing from the gist of the technical idea of the present disclosure.

### EXPLANATION OF REFERENCES

10: regression estimation device
12: data acquisition unit
14: number-of-seconds distribution estimation unit
16: integration unit
18: maximum point specification unit
19: output unit
20: learning model
22: regression estimation unit
24: variable conversion unit
26: logarithmic conversion unit
28: integrated distribution generation unit
102: processor
104: computer-readable medium
104A: memory
104B: storage
106: communication interface
108: input/output interface
110: bus
114: input device
116: display device
130: regression estimation program
200: medical information system
220: medical image processing device
230: modality
231: CT apparatus
232: MRI apparatus
233: Ultrasound diagnostic apparatus
234: PET apparatus
235: X-ray diagnostic apparatus
236: X-ray fluoroscopy apparatus
237: endoscopic apparatus
240: DICOM server
244: electronic medical record system
246: viewer terminal
248: communication line
GD1: graph
GD1g: graph
GD2: graph
GD2g: graph
GL1: graph
GL1g: graph
GL2: graph
GL2g: graph
GLS: graph
GLSg: graph
GRb: graph
GRμ: graph
GROb: graph
IM: image
IM1, IM2, IMn: image
IMi: image
TIM: image
Oa: estimated value
Ob: score value
P1, P2, Pi: probability distribution
PD: number-of-seconds distribution

What is claimed is:

1. A regression estimation device comprising:
one or more processors; and
one or more storage devices that store a program to be executed by the one or more processors,
wherein the one or more processors execute commands of the program
to receive an input of a plurality of data items,
to input the plurality of data items to a single regression model to estimate a plurality of sets of estimated values and certainties of the estimated values from the plurality of data items, and
to integrate estimation results of the plurality of sets on the basis of the plurality of sets of the estimated values and the certainties of the estimated values estimated by the regression model.

2. The regression estimation device according to claim 1,
wherein the one or more processors
estimate a probability distribution having the estimated value as a random variable on the basis of the estimated value and the certainty of the estimated value,
integrate the probability distributions of the plurality of sets to generate an integrated distribution, and
specify a final estimated value on the basis of the integrated distribution.

3. The regression estimation device according to claim 1,
wherein the one or more processors
estimate a probability distribution having the estimated value as a random variable on the basis of the estimated value and the certainty of the estimated value, and
specify a value at which a product of probabilities at the same random variable is maximized on the basis of the probability distribution of each of the plurality of sets.

4. The regression estimation device according to claim 2,
wherein the one or more processors
perform variable conversion to convert the estimated value output from the regression model into a first parameter of a probability distribution model, and
perform variable conversion to convert a value indicating the certainty output from the regression model into a second parameter of the probability distribution model.

5. The regression estimation device according to claim 4,
wherein the probability distribution model is a Laplace distribution.

6. The regression estimation device according to claim 4,
wherein the probability distribution model is a Gaussian distribution.

7. The regression estimation device according to claim 2,
wherein the one or more processors
perform logarithmic conversion to take a logarithm of the probability distribution,
calculate a sum of logarithmic probability densities corresponding to the probability distributions of the plurality of sets during the integration, and
calculate a value at which a simultaneous logarithmic probability density is maximized.

8. The regression estimation device according to claim 1,
wherein the regression model includes a trained model generated by performing machine learning using training data in which data for input and a teaching signal are associated with each other.

9. The regression estimation device according to claim 1,
wherein the regression model is configured using a convolutional neural network.

10. The regression estimation device according to claim 1,
wherein the plurality of data items are medical images.

11. The regression estimation device according to claim 1,
wherein the plurality of data items include different partial images included in a three-dimensional image.

12. The regression estimation device according to claim 1,
wherein the plurality of data items include generated images that are generated on the basis of different partial images included in a three-dimensional image.

13. The regression estimation device according to claim 10,
wherein the estimated value is an elapsed time from injection of a contrast agent.

14. The regression estimation device according to claim 10,
wherein the estimated value is a value that indicates a position of a specific object.

15. The regression estimation device according to claim 11,
wherein the estimated value is a value that indicates a position of the partial image in the three-dimensional image.

16. A regression estimation method executed by a processor, the regression estimation method comprising:
receiving an input of a plurality of data items;
inputting the plurality of data items to a single regression model to estimate a plurality of sets of estimated values and certainties of the estimated values from the plurality of data items; and
integrating estimation results of the plurality of sets on the basis of the plurality of sets of the estimated values and the certainties of the estimated values estimated by the regression model.

17. A non-transitory, computer-readable tangible recording medium on which a program for causing, when read by a computer, a processor of the computer to execute the regression estimation method according to claim 16 is recorded.

18. A method for generating a trained model used as a regression model that receives an input of data and outputs an estimated value and a certainty of the estimated value from the data, the method comprising:
using training data in which data for input and a teaching signal are associated with each other, inputting the data for input to a learning model, and obtaining an output of the estimated value and a value indicating the certainty of the estimated value from the learning model;
performing variable conversion to convert the estimated value output from the learning model into a first parameter of a probability distribution model;
performing variable conversion to convert the value indicating the certainty output from the learning model into a second parameter of the probability distribution model;
calculating a loss function using the first parameter, the second parameter, and the teaching signal; and
updating parameters of the learning model on the basis of a calculation result of the loss function.

19. The method for generating a trained model according to claim 18,
wherein the probability distribution model is a Laplace distribution, and
in a case where the first parameter is μ, the second parameter is b, and the teaching signal is t, the following expression is used as the loss function:
$$log b + \vert t - μ \vert / b .$$

20. The method for generating a trained model according to claim 18,
wherein the probability distribution model is a Gaussian distribution, and
in a case where the first parameter is μ, the second parameter is σ², and the teaching signal is t, the following expression is used as the loss function:
$$log {σ}^{2} + {( t - μ )}^{2} / 2 {σ}^{2} .$$
